(19) United States
(12) Patent Application Publication
(10) Pub. No.: US 2004/0193603 A1
(43) Pub. Date: Sep. 30, 2004

(54) Technique for effectively searching for information in response to requests in information assistance service

(76) Inventor: Philip A. Ljubicich, Lake Forest Park, WA (US)

Correspondence Address: Alex L. Yip, Kaye Scholer LLP, 425 Park Avenue, New York, NY, 10022, US

(21) Appl. No.: 10/402,090

(22) Filed: Mar. 28, 2003

(51) Int. Cl. G06F 7/00

(52) U.S. Cl. 707/9

(57) ABSTRACT

When a current caller makes an information assistance call to an information/call center requesting a listing, the system of the present invention searches for it in databases containing listings actually requested by the current or other callers in the past as opposed to a prior art technique of searching through all the listings in the database for a particular locale or area code. The listings actually requested by callers during prior information assistance calls can be organized in multiple databases. One such database contains only the listings actually requested by the current caller. Another such database contains only the listings actually requested by different callers where such listings are associated with a particular geographic region.

### FIELD OF THE INVENTION

The invention relates to a communications system and method, and more particularly to an information assistance system and method for responding to requests for information and searching databases for requested information.

### BACKGROUND OF THE INVENTION

It is commonplace that a user calls an information assistance service for information, e.g., a telephone listing, with a desired party's name and location, e.g., city and state. In response, the service searches a conventional database, e.g., electronic white pages (EWP), containing listings associated with the specified city and state. However, one such search may be time consuming as the number of listings in the conventional database from which the desired listing is identified is typically large. A significant number of potential matches are often returned in a search. What makes the matter worse is the use of speech recognition technology to transcribe the caller's initial request. The transcription is oftentimes susceptible to error, perhaps because of the caller's accent and/or similar pronunciations of the desired party. As a result, intervention of a live operator is necessary to present potential matches to the user and guide her through all the returned listings to identify the one she desired, thereby rendering the search ineffective.

### SUMMARY OF THE INVENTION

The present invention overcomes the prior art limitations by maintaining databases of listings actually requested by callers in past information assistance calls. One such database is a personal search database which contains listings previously requested by a user. When the same user calls the information assistance system for a listing, the system searches such a personal search database on an assumption that it is likely that a user would request one of her previously requested listings. Such an assumption relies on the fact that the user oftentimes cannot recall a previously requested listing because the user did not record it; the user loses the previously requested listing even when it was recorded; or the user cannot conveniently access her phone book while he/she is driving.

The system in accordance with the present invention may also maintain a regional search database containing listings which were previously requested by different users, and which concern the same geographic region, e.g., a city, state, country, etc. The purpose of such regional search databases is to capture “popular” regional listings. Their popularity stems from the high frequency that users request such listings. In accordance with the invention, one or more of the personal search database and regional search database are searched before the conventional databases in response to a listing request. The advantage of use of the regional search database is that they contain fewer listings than the prior art databases, e.g., EWP, which include all listings for a given geographic region, without regard for the frequency of requests for such listings. In accordance with the invention, by limiting the listings in the databases to those actually requested by users in a past period, the efficiency of a search is improved, which is especially true when the initial request is in voice and is ascertained by speech recognition.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates a communications system including information/call centers in accordance with the invention;

FIGS. 2A and 2B are block diagrams of components of the communications system of FIG. 1;

FIG. 3A illustrates a user search record and personal search database in accordance with the invention.

FIG. 3B illustrates a user search record and personal search database in accordance with the invention.

FIG. 4 illustrates a personal search database memory map in accordance with the invention.

FIG. 5 illustrates a regional search record and regional search database in accordance with the invention;

FIG. 6 illustrates a national search record and a national search database in accordance with the invention;

FIG. 7 is a flow chart depicting a routine for processing of an information assistance call by voice server in accordance with the invention;

FIG. 8A and 8B are flow charts depicting a routine for processing of an information assistance call by database manager in accordance with the invention;

FIG. 9 is a flow chart depicting a routine for processing of an information assistance call by voice server in accordance with the invention;

FIG. 10 illustrates a search template in accordance with the invention; and

FIG. 11 illustrates a result template in accordance with the invention.

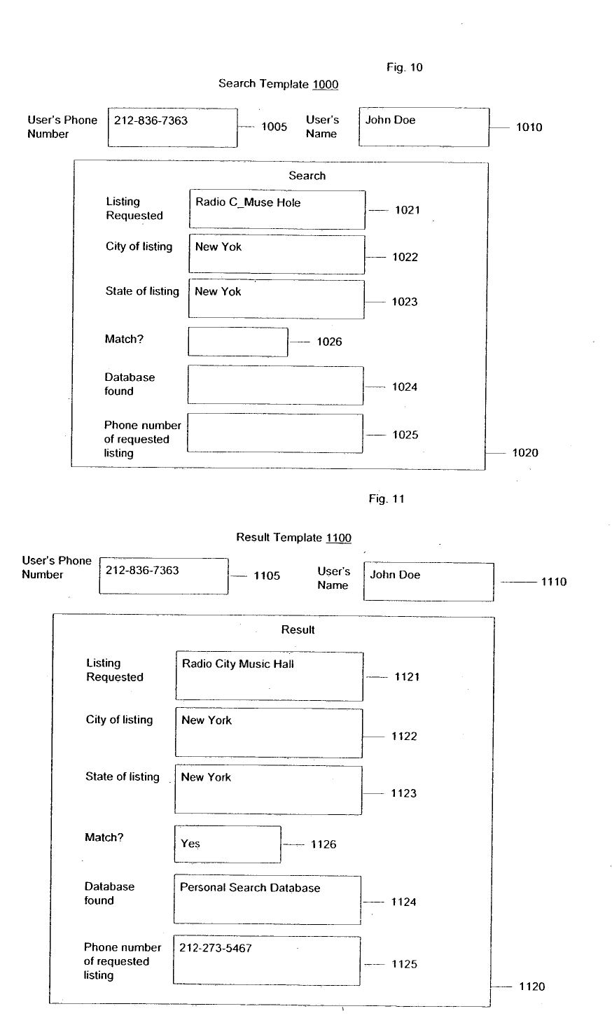

### DETAILED DESCRIPTION

The invention is directed to providing an information assistance service. For example, a user may call the service to request a desired listing. The system in accordance with the present invention improves the likelihood of a correct match by limiting the number of listings searched in response to listing request. This is achieved by maintaining and searching multiple databases of listings actually requested by information assistance callers in the past. One such database, referred to as a personal search database, is identifiable by a user's phone number. The personal search database contains the user's search records resulting from information assistance calls originated from the user's phone number for a period of time. The user search records, fully described and illustrated below, contain at least the name and phone number of the listings requested by the user in the past.

Another database, referred to as a regional search database and fully described and illustrated below, contains different users' search records resulting from information assistance calls made by the users during a period of time requesting listings concerning a particular geographic region, e.g., a city or state. Yet another database, referred to as a national search database and fully described and illustrated below, contains different users' search records resulting from information assistance calls made by the users nationwide during a period of time.

In response to a search request, searching through the listings previously (especially not so long ago) requested by the same user or different users increases a likelihood of obtaining a desired search result. This stems from the fact that users would likely request the same listing repeatedly, e.g., due to user's loss of already requested listing or inaccessibility thereof. For example, the user simply cannot recall the previously requested listing, or it is inconvenient to access her phone book while the user is driving. Searching through the databases of previously requested listings may be performed sequentially. For example, the personal search database is first searched and, if no match is found the regional search database is searched and, if no match is found in the regional search database, the national search database is searched. If no match is found in the databases according to the present invention then a conventional database, e.g., EWP, is searched as in prior art.

The invention is particularly advantageous in the process where the listing request is in voice and is ascertained by speech recognition. Such speech recognition, e.g., involves converting spoken words into transcribed words based on taking the sound profile of the spoken words and comparing it against the sound profiles of a known group of words, whose accuracy is a function of the size of the group. The invention improves the efficiency of searching a database based on an initial voice request by limiting the size of the database. For example, in accordance with the invention, a match is attempted against the aforementioned personal, regional, and national databases whose sizes are reduced compared with the prior art database containing all listings.

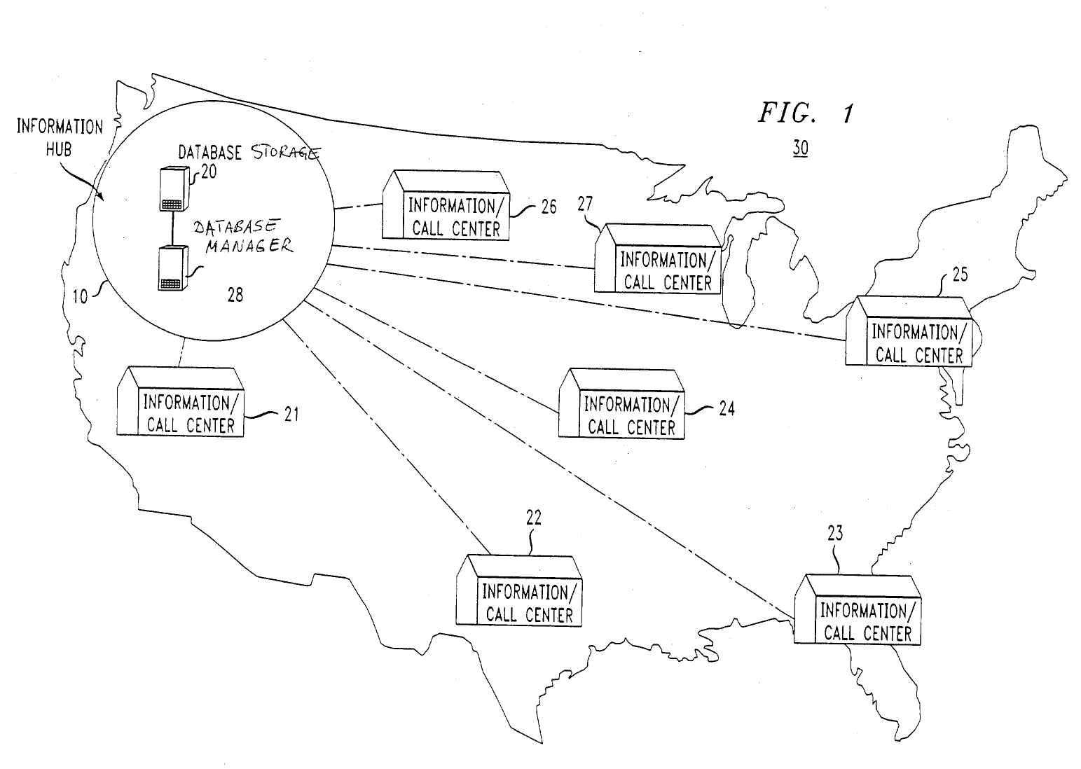

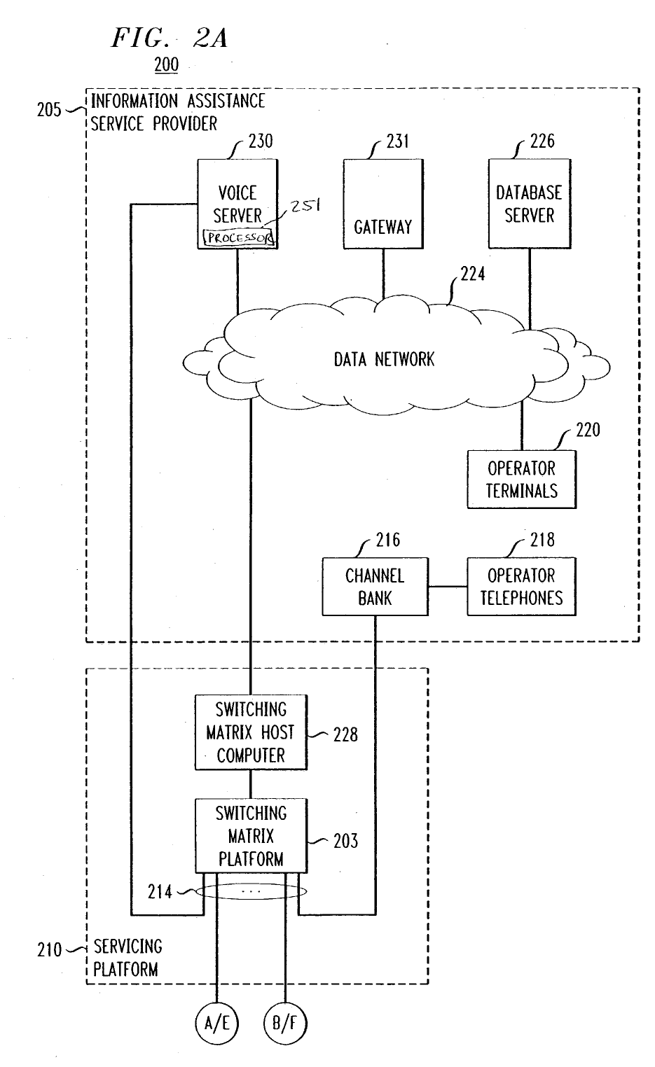

FIG. 1 illustrates a communications system embodying the principles of the invention for providing, inter alia, an improved search for desired listings in the information assistance service. This communication system includes wide area network (WAN) 30 covering an extensive area. WAN 30 may be an Internet-based network such as the World Wide Web or a private Internet based network. WAN 30 connects operators dispersed throughout a wide coverage area in information/call centers 21 through 27. One or more information hubs 10 are also included in WAN 30. An information hub 10 includes one or more database managers 28 which are accessible by the operators in the system, and one or more database storages 20 in which the databases of the present invention, e.g., personal search database, regional search database, or national search database, may be stored and maintained. (Such databases may also be duplicated and stored locally at one or more of the information/call centers.) Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 226 provides access to, among others, directory information from multiple sources. In addition, database server 226 stores the databases of the present invention, e.g., personal search database, regional search database, or national search database. Data network 224 further connects to voice server 230, gateway 231, and switching matrix host computer 228, which in turn is connected to switching matrix platform 203 via a data link.

In FIG. 2B, a user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component. If the outgoing call is being placed over a different network than that on which the incoming call was received, a second data connection to the outgoing network will be established.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230, which among other things contains processor 251, is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto. Voice server 230 is employed to play the constantly repeated parts of an operator's speech, namely, the various greetings and sign offs (or closings), the caller's desired telephone number where requested, and possibly other information. At appropriate stages in a call progression, switch matrix host computer 228 initiates a voice path connection between voice server 230 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

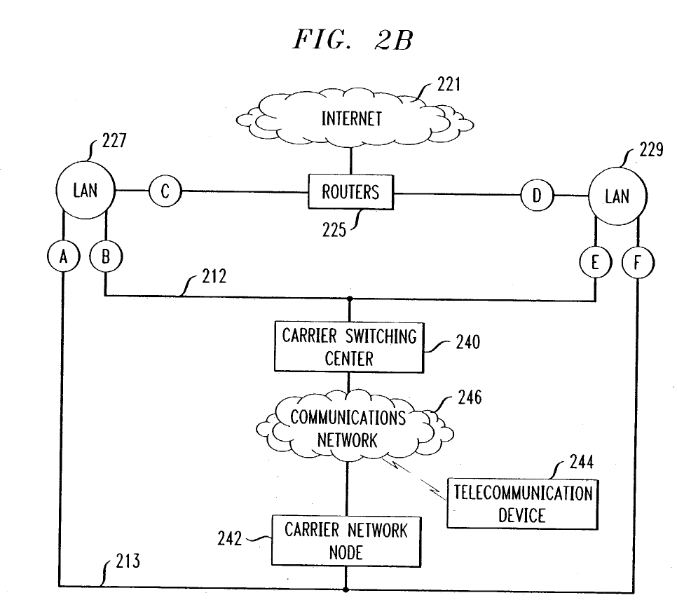

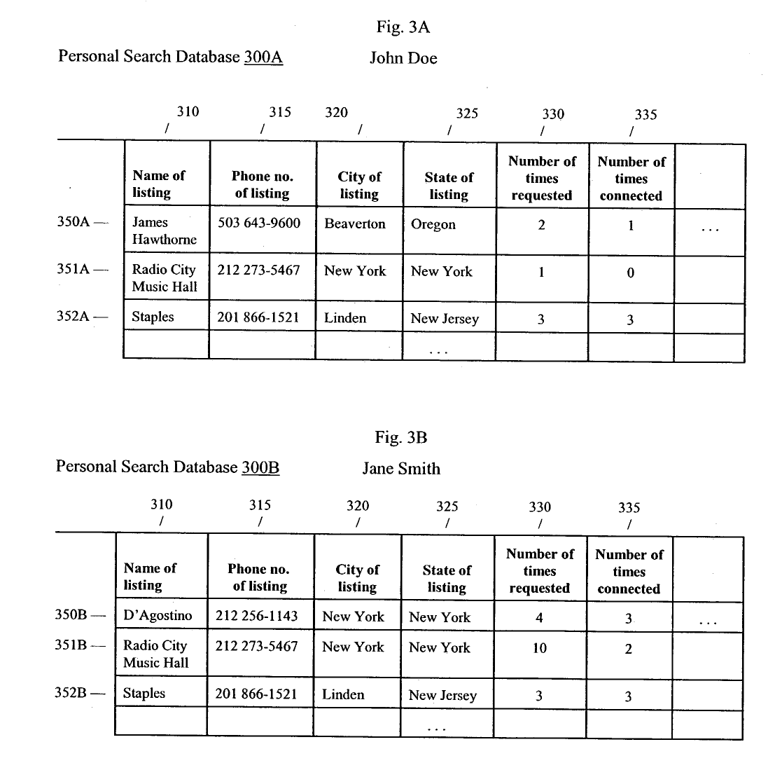

Upon completion of each information assistance call of a user to information/call center 200, database server 226 sends information about the completed call to database manager 28 which creates a user search record which contains, among others, seven fields storing information about such a call as illustrated in FIG. 3A. Multiple user search records are stored together in a personal search database 300A as illustrated in FIG. 3A. Name of Listing field 310 stores the name of a person or entity requested by the user during the just completed information assistance call. Phone Number of Listing field 315 stores the area code and phone number of the same listing having the corresponding Name of Listing field 310. City of Listing field 320 and State of Listing field 325 store the city and state of the same listing having the corresponding Name of Listing field 310. Number of Times Requested field 330 serves as a counter counting how many times within a period of time the user has requested the same listing having the corresponding Name of Listing field 310. Number of Times Connected field 335 serves as a counter counting how many times within a period of time the user has been connected to the same listing corresponding to Name of Listing field 310 by the information assistance service. Additional fields may include, e.g., Street Address of Listing field (not shown) which contains the street address of the same listing having the corresponding Name of Listing field 310.

In this example, personal search database 300A contains three user search records. User search record 350A is for the listing of James Hawthorne (stored in name of listing 310), of Beaverton, Oreg. (stored in field 320 and field 325, respectively). Counter 330 of user search record 350A indicates that the user requested the listing of James Hawthorne twice. Counter 335 of user search record 350A indicates that the user was connected to James Hawthorne once (out of two times he requested this listing).

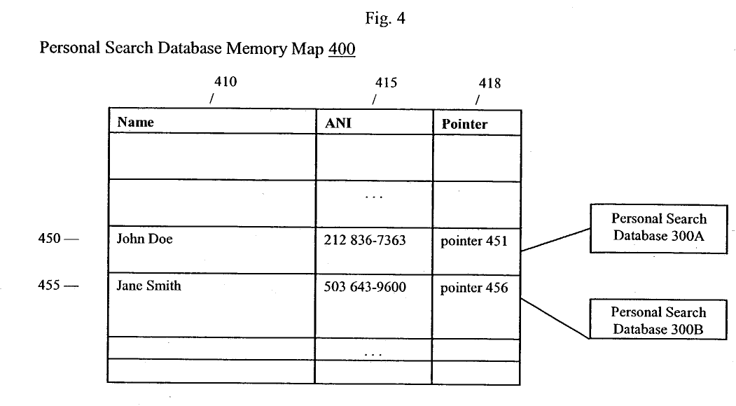

Database manager 28 stores personal search databases for different users in database storage 20 and organizes them according to personal search database memory map 400, stored in database storage 20, and illustrated in FIG. 4. Each record in memory map 400 includes three fields. Name field 410 contains the user's name. ANI field 415 contains the phone number of the user whose name is stored in Name field 410. Pointer field 418 contains a pointer to (or a memory address of) the user's personal search database containing user search records of prior information assistance calls of the user corresponding to Name field 410. In this example, memory map 400 illustrated in FIG. 4 contains, among others, two records. Record 450 is for John Doe (stored in Name field 410) and stores pointer 451 pointing to personal search database 300A, which contains user search records for prior information assistance calls made by John Doe. Record 455 is for Jane Smith (stored in Name field 410) and stores pointer 456 pointing to personal search database 300B, which contains user search records for prior information assistance calls made by Jane Smith.

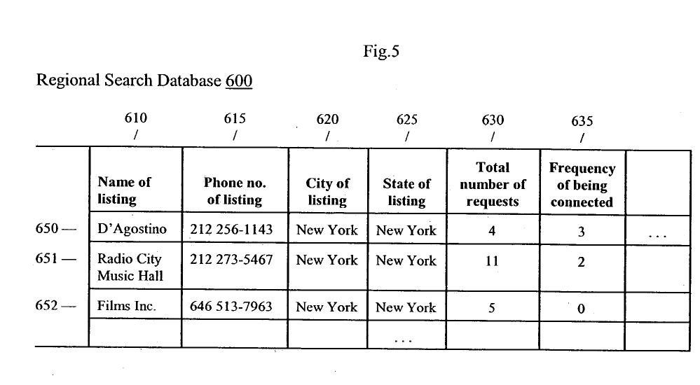

Assuming that the only two users who requested listings in New York City, i.e., the 212 and 646 area codes, during the last month are John Doe and Jane Smith, FIG. 5 illustrates regional search database 600 for New York City. The purpose of such regional search databases is to capture “popular,” i.e., frequently requested, listings concerning a particular region, e.g., New York City in this instance. Each regional search record of regional search database 600 contains aggregated data about information assistance calls made by different users nationwide requesting listings within a particular geographic region. Each record of regional search database 600 includes, among others, seven fields. Name of Listing field 610 stores the name of a person or entity requested by different users during all of the information assistance calls during a period of time, e.g., the last month. Phone Number of Listing field 615 stores the area code and phone number of the same listing having the corresponding Name of Listing field 610. City of Listing field 620 and State of Listing field 625 store the city and state of the same listing having the corresponding Name of Listing field 610. Total Number of Requests field 630 serves as a counter counting how many times within a period of time different users in the U.S. have requested the same listing having the corresponding Name of Listing field 610. Frequency of Being Connected field 635 serves as a counter counting how many times within a predetermined period any user in the U.S. has requested to be connected to the same listing having the corresponding Name of Listing field 610. Additional fields may include, e.g., Street Address of Listing field (not shown) which contains the street address of the same listing having the corresponding Name of Listing field 610.

In this example, regional search record 650 for D'Agostino (stored in Name of Listing field 610) is copied to regional search database 600 from user search record 350B of personal search database 300B for user Jane Smith. Since John Doe's personal search database 300A did not contain any user search record 301 for D'Agostino, user search record 350B was added to regional search database 600 exactly as it was stored in personal search database 300B. Regional search record 651 is for the Radio City Music Hall (stored in Name of Listing field 610). The listing for the Radio City Music Hall is contained in both of John Doe's personal search database 300A (record 351A) and Jane Smith's personal search database 300B (record 351B). Despite that multiplicity in personal search databases, regional search database 600 contains only one record 651 for the Radio City Music Hall, and the value in Frequency of Being Connected field 635 of regional search record 651 is a sum of those in Number of Times Connected fields 335 of user search records 351A and 351B.

Total Number of Requests field 630 of regional search record 651 stores 11 as its value, which is a sum of Number of Times Requested field 330 of user search record 351 A (value of 1) and of user search record 351B (value of 10). Frequency of Being Connected field 635 of regional search record 651 stores 2 as its value, which is a sum of Number of Times Connected field 335 of user search record 351A (value of 0) and of user record search 351B (value of 2).

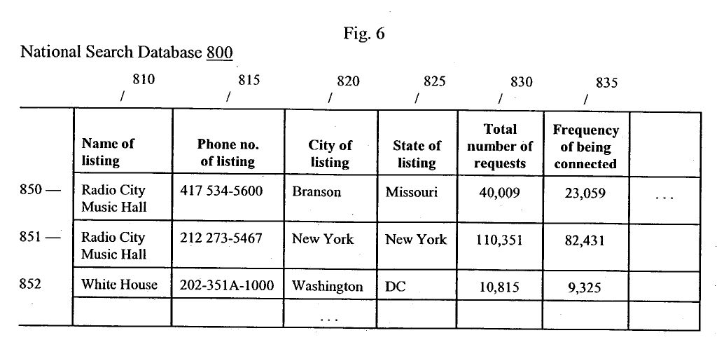

FIG. 6 illustrates a national search database 800. In this embodiment, national search database 800 is compiled by selecting from all of the regional search databases. regional search records with the values of Total Number of Requests field 830 exceeding a predetermined number, in this example, say 10,000 requests for the last month. This number of requests cutoff enables the system of the present invention to include in national search database 800 only the listings that were frequently requested by users nationwide and thus improve the speed of searching and possibility of matching the requested listing.

Each national search record of national search database 800 includes, among others, seven fields and contains aggregated data about information assistance calls made by any user within the U.S. requesting listings in any geographic region nationwide. Name of Listing field 810 stores the name of a person or entity whose listing was requested by different users in all of the information assistance calls during a period of time, e.g., the last month. Phone Number of Listing field 815 stores the area code and phone number of the same listing having the corresponding Name of Listing field 810. City of Listing field 820 and State of Listing field 825 store the city and state of the same listing having the corresponding Name of Listing field 810. Total Number of Requests field 830 serves as a counter counting how many times within a period of time different users nationwide have requested the same listing having the corresponding Name of Listing field 810. Frequency of Being Connected field 835.serves as a counter counting how many times any user who searched for the same listing having the corresponding Name of Listing field 810 requested to be connected to it. Additional fields may include, e.g., Street Address of Listing field (not shown) which contains the street address of the same listing having the corresponding Name of Listing field 810.

In this example, national search record 850 is for the Radio City Music Hall (stored in Name of Listing field 810) in Branson, Mo. (stored in City of Listing field 820 and State of Listing field 825, respectively) with 40,009 stored in Total Number of Requests field 830 and 23,059 stored in the Frequency of Being Connected field 835. National search record 851 is for the Radio City Music Hall (stored in Name of Listing field 810) in New York, N.Y. (stored in City of Listing field 820 and State of Listing field 825, respectively) with 110,351 stored in Total Number of Requests field 830 and 82,431 stored in the Frequency of Being Connected field 835. National search record 852 is for the White House (stored in Name of Listing field 810) in Washington, D.C. (stored in City of Listing field 820 and State of Listing field 825, respectively) with 10,815 stored in Total Number of Requests field 830 and 9,325 stored in the Frequency of Being Connected field 835.

When the user uses telecommunication device 244, e.g., a telephone, to call an operator at a designated access number for information assistance, the call is routed to, say, information/call center 200. Referring back to FIG. 2A, an information assistance call is received by switching matrix platform 203 in center 200, In a well known manner, platform 203 derives, from the call set-up signals associated with the call, an automatic number identification (ANI) indicating the telephone number of the communication device from which the call originates. Switching matrix host computer 228 causes voice server 230 to seize the instant information assistance call.

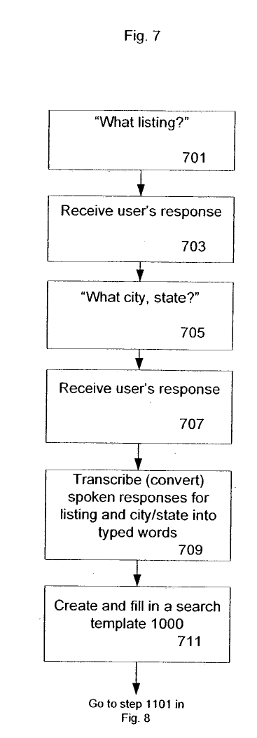

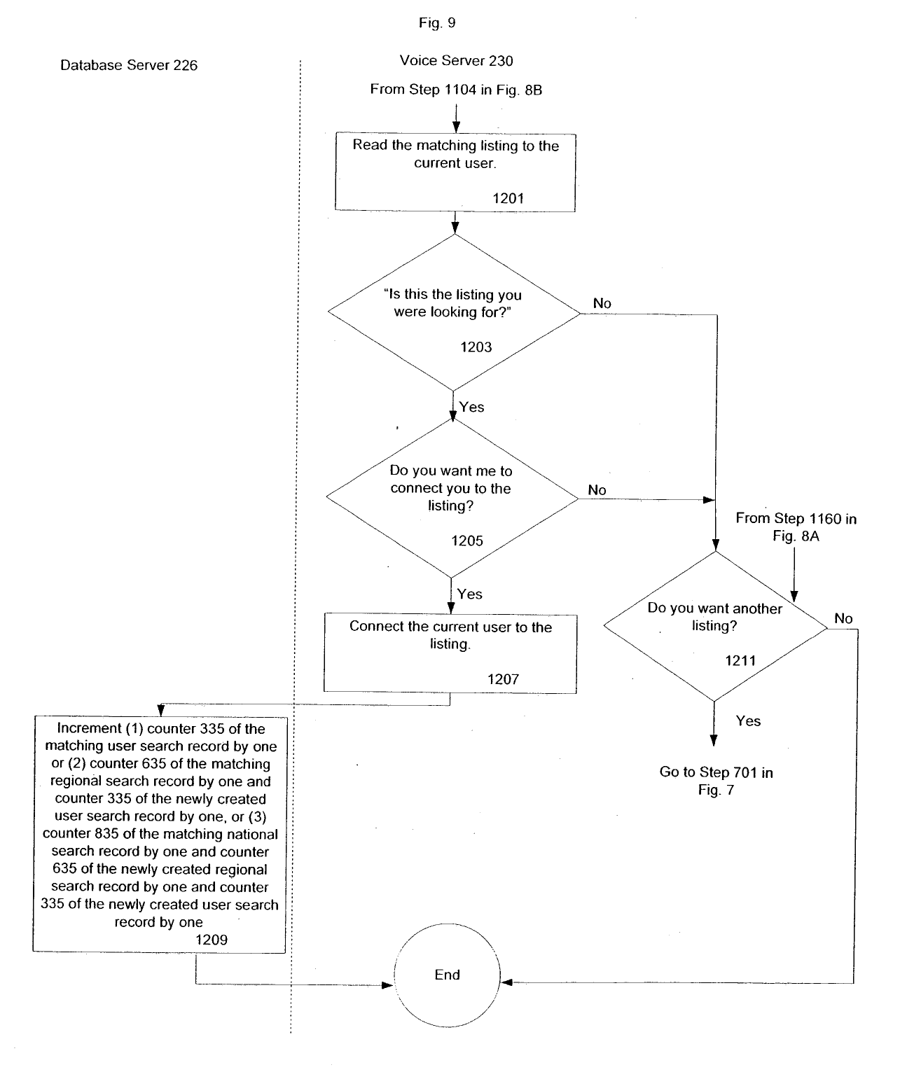

FIG. 7 illustrates a routine for processing an information assistance call by voice server 230 according to the system of the present invention. In this example, user named John Doe places a call from the phone number 212-836-7363 to information/call center 200. In step 701, voice server 230 asks the user what listing he is looking for. In step 703, voice server 230 receives John's response, say “Radio City Music Hall”. In step 705, voice server 230 prompts John “what city and state?” In step 707, voice server 230 receives John's response “New York, N.Y.”. In step 709, using well-known techniques of speech recognition, processor 251 of voice server 230 translates spoken request for “Radio City Music Hall” into typed words “Radio C₁₃ Muse Hole”. In the same step 709, processor 251 transcribes spoken request for city and state “New York, N.Y.” into “New York, N.Y.” In step 711, voice server 230 causes gateway 231 to create and fill out search template 1000, illustrated in FIG. 10, with the information about the user and his request for the listing. Search template 1000 would be provided to an operator if voice server 230 cannot assist the user and services of a live operator are necessary.

Search template 1000, as illustrated in FIG. 10, consists of multiple fill-in boxes. User's Phone Number box 1005 contains the phone number of the current user; in this example, it is 212-836-7363. User's Name box 1010 contains the name of the current user, e.g, John Doe. The fill-in boxes containing information about the requested listing are grouped together in Search field 1020. Listing Requested box 1021 is filled in with the name of the requested listing. In this example, at step 711, gateway 231 fills in Listing Requested box 1021 with the name of the requested listing transcribed in step 709 (“Radio C₁₃ Muse Hole”), as illustrated in FIG. 10. Also in step 711, gateway 231 fills in City of Listing box 1022 and State of Listing box 1023 with the city and state of the requested listing as transcribed in step 709 (“New York” and “New York”), as illustrated in FIG. 10. The rest of the fill-in boxes remain empty at step 711.

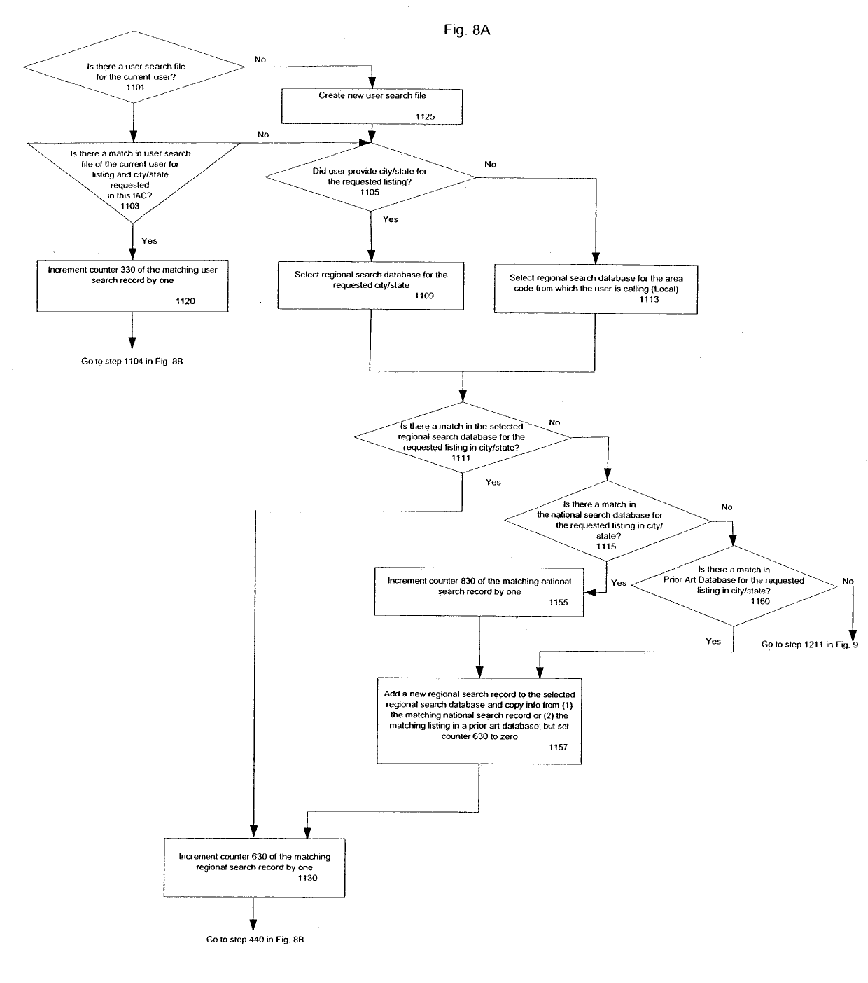

After creating and filling out search template 1000 in step 711, voice server 230 sends a request, including John Doe's ANI through gateway 231 to database server 226 to search database storage 20 for John Doe's personal search database. Database server 226 passes this request along for processing to database manager 28. FIGS. 8A and 8B depict a routine executed by database manager 28 for processing a search for the requested listing. In step 1101, database manager 28 retrieves memory map 400 and searches ANI field 415 of memory map 400 to find a match for John Doe's ANI. In this instance, database manager 28 finds record 450 and retrieves John Doe's personal search database 300A based on the memory location indicated by value in Pointer field 418. In step 1103, database manager 28 searches Name of Listing field 310, City of Listing field 320, and State of Listing field 325 of John Doe's personal search database 300A to find a match for “Radio C₁₃ Muse Hole” in “New York, N.Y.”.

In this instance, according to the well-known techniques, database manager 28 matches the requested listing with user search record 351A of John Doe's personal search database 300A. Database server 226 uses information from user search record 351A to fill out result template 1100. Database manager 28 copies information from Name of Listing field 310 of user search record 351A (“Radio City Music Hall”) into Listing Requested field 1121. Database manager 28 also copies information from City of Listing field 320 and State of Listing field 325 of user search record 351A into City of Listing box 1122 and State of Listing box 1123 (“New York” and “New York”). Database manager 28 next copies information from Phone Number of Listing field 315 of user search record 351A into Phone Number of Requested Listing box 1125 (“212 273-5467”). Then, database manager 28 fills out Match box 1126 with “yes” because a match was found and fills out Database Found box 1124 with “personal search database.” In step 1120, database manager 28 increments counter 330 of the matched user search record 351 A by one. Since there is a match for the requested listing, in step 1104, database manager 28 sends the filled out result template 1100 through gateway 231 to database server 226, which processes it and ultimately passes it to voice server 230.

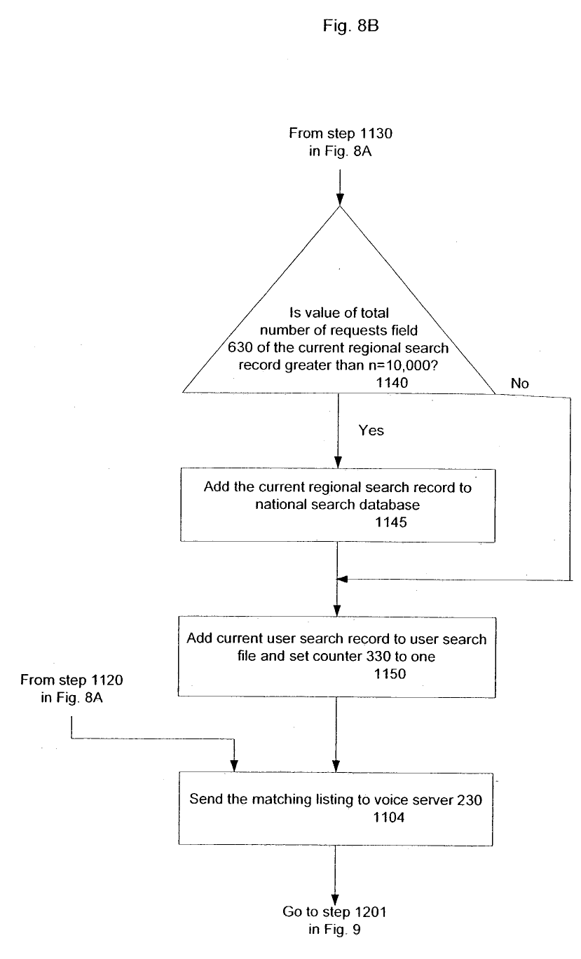

At this point, further processing of the information assistance call is turned over to voice server 230. FIG. 9 depicts a routine executed by voice server 230 when a match for the requested listing is found. In step 1201, voice server 230 reads the matching listing to the user. In this example, voice server 230 reads “Radio City Music Hall in New York, N.Y.” to John Doe. In step 1203, voice server 230 asks John Doe whether the announced listing is the listing he was looking for. The user can respond to this request either by pressing a designated key on the keypad or saying “Yes” or “No”. In this example, the user was looking for “Radio City Music Hall in New York, N.Y.,” and he responds affirmatively. In step 1205, voice server 230 asks the user whether he wants to be connected to “Radio City Music Hall in New York, N.Y.” In this example, the user wants to be connected and responds affirmatively to the question in step 1205. In step 1207, voice server 230 ceases control of the information assistance call to switching matrix host computer 228 which then connects the user to (212) 273-5467 of Radio City Music Hall in New York, N.Y. In addition, in step 1207, voice server 230 transfers further handling of the information about the current information assistance call to database manager 28 (through gateway 231 and database server 226). Since database manager 28 reaches step 1209 from step 1103, it executes option (1) of step 1209, in which database manager 28 increments counter 335 of the matching user search record 351A of John Doe's personal search database 300A by one. (Database manager 28 keeps track of the path of executing the routine depicted in FIGS. 8A and 8B.)

Continuing with the example of routine depicted in FIG. 9, if in response to the question in step 1203 whether the matched listing is the one user requested, John replies “No,” voice server 230 goes to step 1211. In addition, voice server 230 may reach step 1211 from step 1205 if the user does not want the system of the present invention to connect him to the matched listing. In step 1211, voice server 230 asks the user whether he wants to request another listing. If the user wants to request another listing, voice server 230 goes to step 701 of FIG. 7 described above. If the user does not want to request another listing, voice server 230 sends instructions to disconnect the call to switching matrix host computer 228 and routine depicted in FIG. 9 ends.

Continuing the present example at step 1101 of FIG. 8 depicting a routine executed by database manager 28, if database manager 28 does not find a personal search database for the current user in memory map 400, database manager 28 in step 1125, creates a new record in memory map 400, stores current user's name and ANI in it, creates a corresponding personal search database, and goes to step 1105. In addition, database manager 28 also reaches step 1105 if in step 1103 database manager 28 does not find a match for “Radio C_Muse Hole” in John Doe's personal search database 300A. In step 1105, database manager 28 checks whether the user said what city and state the listing is for. In this example, since John responded with “New York, N.Y.” to request in step 705 (transcribed as “New York, N.Y.”), database manager 28 goes to step 1109. In step 1109, database manager 28 selects a regional search database 600 for the requested city and state, New York, N.Y., which is assigned the 212 and 646 area codes. In step 1111, database manager 28 searches regional search database 600 for the requested listing “Radio C_Muse Hole.” In this example, database manager 28 matches “Radio C_Muse Hole” with “Radio City Music Hall” in Name of Listing field 610 of regional search record 651. Database manager 28 in step 1130 increments counter 630 of the matching regional search record 651 by one. In step 1140, database manager 28 compares the value of Total Number of Requests field 830 of the matching regional search record selected in step 1111 with the predetermined number, in this instance say 10,000. If it is more than 10,000, then in step 1145 database manager 28 appends a new national search record to national search database 800 and copies information from the matching regional search record, e.g., regional search record 651, into the new national search record. In step 1150, database manager 28 appends a new user search record to personal search database for the current user, copies information from the matching regional search record into the new user search record, and sets counter 330 to one. Database manager 28 then goes to step 1104 described above. If database manager 28 reaches step 1209 from step 1111, it executes option (2) of step 1209, in which database manager 28 increments counter 635 of the matching regional search record by one and increments counter 335 of the newly appended user search record by one. If in step 1140 database manger 28 determines that the value of Total Number of Requests field 830 of the matching regional search record is less than 10,000 database manger 28 proceeds to step 1150 described above.

Continuing with the present example at step 1105, if the user did not specify, in step 1005, the city and state for the requested listing, then database manager 28 goes to step 1113. In step 1113, database manager 28 assumes that the user requested a listing in the same area code from which the user is calling, selects the area code from the user's ANI, and selects a regional search database for the geographic region corresponding to the area code of the user's ANI.. Then, database manager 28 executes step 1111. If in step 1111, database manager 28 could not find a match for the requested listing, e.g., “Radio C_Muse Hole,” in regional search database, which was selected in step 1109 or in step 1113, database manager 28 goes to step 1115. In step 1115, database manager 28 searches Name of Listing field 810 of national search database 800 for “Radio C_Muse Hole.” In this example, database manager 28 matches “Radio C_Muse Hole” with “Radio City Music Hall” in Name of Listing field 810 of national search records 850 and 851 of national search database 800. Since there are two matches, database manager 28 proceeds to compare the information in City of Listing field 820 and State of Listing field 825 of national search records 850 and 851 with the requested location of “New York, N.Y.”. As a result, database manager 28 selects national search record 851. In step 1155, database manager 28 increments counter 830 of the matching national search record 851 by one. If database manager 28 reaches step 1157 from step 1155, database manager 28 executes option (1) in step 1157, in which it appends a new regional search record to the selected regional search database and copies information from the matching national search record 851 into the new regional search record but sets counter 630 to zero. (Database manager 28 keeps track of the path of executing the routine depicted in FIGS. 8A and 8B.) Then, database manager 28 proceeds to step 1130. If database manager 28 reaches step 1209 from step 1155, it executes option (3) of step 1209, in which database manager 28 increments counter 835 of the matching national search record, increments counter 635 of the newly appended regional search record, and increments counter 335 of the newly appended user search record.

If in step 1115, database manager 28 did not find a match for the requested listing in national search database 800, database manager 28 proceeds to step 1160 to process the call according to prior art techniques where a search for the requested listing is conducted in an appropriate prior art database of all listings for the city and state combination requested by the user. If in step 1160 database manager 28 finds a match for the requested listing in the prior art database, then database manager 28 proceeds to step 1157 and executes option (2) of step 1157, i.e., copies information from the matching listing in the prior art database into the newly appended regional search record, but sets counter 630 to zero. Database manager 28 continues processing to step 1130. If database manager 28 reaches step 1209 from step 1160, it executes option (2) of step 1209, in which database manager 28 increments counter 635 of the newly appended regional search record by one and increments counter 335 of the newly appended user search record by one. If in step 1160 database manager 28 does not find a match in the prior art database for the requested listing, then database manager 28 proceeds to step 1211 of FIG. 9, as described above.

It would be appreciated by those skilled in the art, that the records of prior information assistance calls can be organized in databases using different principles than having been made by the same caller, or requested listings associated with the same geographic region. For example, these records can be associated together in a database of all calls originating from a particular state, where information assistance calls from all area codes associated with the particular state are collected in one database (regardless of the geographic location of where the requested listings are located).

Additional databases may be created using other factors to group records of prior information assistance calls. For example, such databases may be created in conjunction with users' personal profiles, which contain information about, among others, a user's occupation, language preferences, etc. Additional databases may be created grouping all prior information assistance calls of a particular group of professionals, e.g., doctors, nurses, medical workers, lawyers, within a particular geographic region, e.g., same area code, same city, same state, etc., during a selected period of time. In addition, information assistance calls of all callers who expressed a particular language preference, e.g., Spanish, Italian, Russian, Chinese, can be grouped together in a database within a particular geographic region, e.g., same area code, same city, same state, etc.

It would be appreciated by those skilled in the art that a single user has access to multiple telephones or communication devices, e.g., a house phone, a work phone, a cellular phone, and is likely to make information assistance calls from any of them. Since the system of the present invention improves the likelihood of matching a request for a desired listing by searching through previously requested listings, it is desirable to link all of the information assistance call records for all of information assistance calls of the same user regardless of which phone or device the user made any of the calls. To this end, when the system of the present invention recognizes that an information assistance caller is placed from a wireless phone or a phone assigned to a business, it may automatically ask the user to provide a list of phone numbers the user has used in the past for placing information assistance calls. However, most likely, such a list of other phone numbers is specified in the user's personal profile stored in the system, thereby obviating the need of asking the same repeatedly. Based on this list, the information assistance system links all personal search databases associated with these phone numbers and searches them as if it were a single personal search database.

The foregoing merely illustrates the principles of the invention. It will thus be appreciated that those skills in the art will be able to devise numerous other arrangements which embody the principles of the invention and are thus within its spirit and scope.

For example, the invention equally applies regardless of whether feature group D (FGD) type signaling, SS7 out-of-band signaling or other signaling is used for communications between carrier switches and switching matrix platform 203 of FIG. 2A.

Finally, information/call center 200 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing an information assistance service in response to a current information assistance call from a user, comprising:
maintaining a selected database which is associated with an identifier identifying a communications device and which collects listings having been requested by the user in prior information assistance calls;
receiving the current information assistance call from the user, the call including a request for a desired listing, along with signals for setting up the call, the signals containing the identifier identifying the communications device from which the call originates;
deriving the identifier from the signals;
identifying the selected database based on the derived identifier; and
searching the selected database in response to the request.

2. The method of claim 1 further comprising maintaining a second database, which includes second listings having been requested in prior information assistance calls, the second listings being associated with at least one geographic area.

3. The method of claim 2 further comprising if the desired listing is not found in the selected database, searching the second database for the desired listing, and if the desired listing is found in the second database, incorporating the found listing into the selected database.

4. The method of claim 1 wherein the prior information assistance calls originated from different communications devices.

5. The method of claim 1 wherein the identifier includes a telephone number.

6. The method of claim 1 wherein the identifier includes an automatic number identification (ANI).

7. The method of claim 2 wherein the geographic area is associated with one or more zip code.

8. The method of claim 2 wherein the geographic area is associated with one or more telephone area code.

9. The method of claim 2 wherein the geographic area is a city.

10. The method of claim 2 wherein the geographic area is a state.

11. The method of claim 2 wherein the geographic area is a region.

12. The method of claim 2 wherein the geographic area is a country.

13. The method of claim 1 wherein the selected database is organized according to the originations of the prior information assistance calls.

14. A method for providing an information assistance service in response to a current information assistance call, comprising:
maintaining a selected database, which collects listings having been requested in prior information assistance calls, the listings pertaining to at least one geographic area;
receiving the current information assistance call, the call including a request for a desired listing pertaining to the geographic area; and
in response to the request, searching the selected database.

15. The method of claim 14 further comprising
if the desired listing is not found in the selected database, searching a second database for the desired listing, and if the desired listing is found in the second database, incorporating the found listing into the selected database.

16. The method of claim 14 wherein the selected database is organized according to the originations of the prior information assistance calls.

17. The method of claim 14 wherein the geographic area is associated with one or more zip code.

18. The method of claim 14 wherein the geographic area is associated with one or more telephone area code.

19. The method of claim 14 wherein the geographic area is a city.

20. The method of claim 14 wherein the geographic area is a state.

21. The method of claim 14 wherein the geographic area is a region.

22. The method of claim 14 wherein the geographic area is a country.

23. A system for providing an information assistance service in response to a current call from a user, comprising:
a selected database, which is associated with an identifier identifying a communications device and which collects listings having been requested by the user in prior information assistance calls;
an interface for receiving the current information assistance call from the user, the call including a request for a desired listing, along with signals for setting up the call, the signals containing the identifier identifying the communications device from which the call originates, the identifier being derived from the signals;
a mechanism for identifying the selected database based on the derived identifier; and
a processor responsive to the request for searching the selected database.

24. The system of claim 23 further comprising a second database, which includes second listings having been requested in prior information assistance calls, the second listings being associated with at least one geographic area.

25. The system of claim 24 wherein if the desired listing is not found in the selected database, the second database is searched for the desired listing, and if the desired listing is found in the second database, the found listing is incorporated into the selected database.

26. The system of claim 23 wherein the prior information assistance calls originated from different communications devices.

27. The system of claim 23 wherein the selected database is organized according to the originations of the prior information assistance calls.

28. The system of claim 23 wherein the identifier includes a telephone number.

29. The system of claim 23 wherein the identifier includes an ANI.

30. The system of claim 24 wherein the geographic area is associated with one or more zip code.

31. The system of claim 24 wherein the geographic area is associated with one or more telephone area code.

32. The system of claim 24 wherein the geographic area is a city.

33. The system of claim 24 wherein the geographic area is a state.

34. The system of claim 24 wherein the geographic area is a region.

35. The system of claim 24 wherein the geographic area is a country.

36. A system for providing an information assistance service in response to a current information assistance call, comprising:
a selected database, which collects listings having been requested in prior information assistance calls, the listings pertaining to at least one geographic area;
an interface for receiving the current information assistance call, the call including a request for a desired listing pertaining to the geographic area; and
a processor for searching the selected database in response to the request.

37. The system of claim 36 wherein if the desired listing is not found in a selected database, the second database is searched for the desired listing, and if the desired listing is found in the second database, the found listing is incorporated into the selected database.

38. The system of claim 36 wherein the selected database is organized according to the originations of the prior information assistance calls.

39. The system of claim 36 wherein the geographic area is associated with one or more zip code.

40. The system of claim 36 wherein the geographic area is associated with one or more telephone area code.

41. The system of claim 36 wherein the geographic area is a city.

42. The system of claim 36 wherein the geographic area is a state.

43. The system of claim 36 wherein the geographic area is a region.

44. The system of claim 36 wherein the geographic area is a country.
